(19) United States
(12) Patent Application Publication
(10) Pub. No.: US 2019/0367011 A1
(43) Pub. Date: Dec. 5, 2019

(54) Hybrid Electric Vehicle With Park Assist

(71) Applicant: Ford Global Technologies, LLC, Dearborn, MI (US)

(72) Inventors: Rajit Johri, Canton, MI (US); Fazal Syed, Canton, MI (US)

(21) Appl. No.: 15/996,771

(22) Filed: Jun. 4, 2018

(51) Int. Cl. B60W 20/40; B60W 10/06; F02N 11/08

(52) U.S. Cl. CPC B60W 20/40; B60W 10/06; F02N 11/0862; F02N 11/0833; F02N 2200/061; B60W 2510/244; B60Y 2200/92; Y10S 903/903; B60Y 2300/06

(57) ABSTRACT

A hybrid vehicle includes an automated parking feature. A controller restarts the engine upon activation of the automated parking feature in situation where the normal engine starting control would have started the engine during the parking maneuver. As a result, engine starts during the parking maneuver are avoided.

### TECHNICAL FIELD

This disclosure relates to the field of hybrid electric vehicles. More particularly, the disclosure pertains to a control strategy for determining when to operate the internal combustion engine during an automated parking maneuver.

### BACKGROUND

Hybrid vehicle transmissions improve fuel economy by providing energy storage. In a hybrid electric vehicle, for example, energy may be stored in a battery. The battery may be charged by operating the engine to produce more power than instantaneously required for propulsion. Additionally, energy that would otherwise be dissipated during braking can be captured and stored in the battery. The stored energy may be used later, allowing the engine to produce less power than instantaneously required for propulsion and thereby consuming less fuel. The engine may be alternately turned off when the battery is at high charge and then restarted when the battery is at low charge.

Some vehicles, both hybrid and conventional, have automated parking features. The automated parking feature is selected by the user while looking for a suitable parking spot and then activated after finding a suitable spot. Once activated, the feature manipulates the powertrain, brakes, and steering to maneuver the vehicle into the parking spot.

### SUMMARY OF THE DISCLOSURE

A hybrid electric vehicle includes an internal combustion engine, a battery, and a controller. The controller is programmed to start the engine responsive to a battery state of charge decreasing below a first threshold. The controller is also programmed to start the engine responsive to initiation of an automated parking feature and the state of charge being greater than the first threshold and less than a second threshold. The second threshold may vary depending upon the type of parking maneuver to be performed (head-in, back-in, or parallel, for example). In some embodiments, the second threshold may be adjusted based on a measured change in state of charge during a previous automated parking maneuver. In some embodiments, the controller may calculate the second threshold based on segment distances and driveline loss characteristics. The controller may also be programmed to complete a parking procedure without starting the engine responsive to initiation of the automated parking feature and the state of charge being greater than the second threshold. The controller may be further programmed to stop the engine responsive to a battery state of charge increasing to greater than a third threshold and to delay stopping the engine until after an automated parking maneuver is completed in response to the state of charge increasing to greater than the third threshold during the automated parking maneuver.

A hybrid electric vehicle includes an internal combustion engine, a battery, and a controller. The controller is programmed to respond to a request for an automated parking feature by starting the engine before starting the parking procedure responsive to a battery state of charge being less than a first threshold, and then completing the parking procedure without starting the engine responsive to the state of charge being greater than the first threshold. The controller may be further programmed to start the engine prior to initiation of the automated parking feature responsive to the state of charge decreasing below a second threshold less than the first threshold. The controller may also be further programmed to stop the engine responsive to a battery state of charge increasing to greater than a third threshold, and delay stopping the engine until after the automated parking maneuver is completed in response to the state of charge increasing to greater than the third threshold during the automated parking maneuver.

A method includes starting an internal combustion engine, stopping the engine, restarting the engine, and completing a parking procedure without stopping the engine. The engine is started responsive to a battery state of charge decreasing below a first threshold. The engine is stopped responsive to the battery state of charge increasing above a second threshold. The engine is restarted responsive to initiation of an automated parking feature and the battery state of charge being between the first threshold and a third threshold. The third threshold may be selected such that completing the parking procedure without restarting the engine would result in the battery state of charge decreasing below the first threshold. The third threshold may vary based on a type of parking procedure to be performed. The method may also include adjusting the third threshold based on a measured change in battery state of charge to complete an automated parking procedure.

### BRIEF DESCRIPTION OF THE DRAWINGS

FIG. 1 is a schematic diagram of a hybrid electric powertrain.

FIG. 2 is a flow chart for a method of determining when to start and stop the engine of the powertrain of FIG. 1.

FIG. 3 is a flow chart for responding to automated parking requests in the powertrain of FIG. 1.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

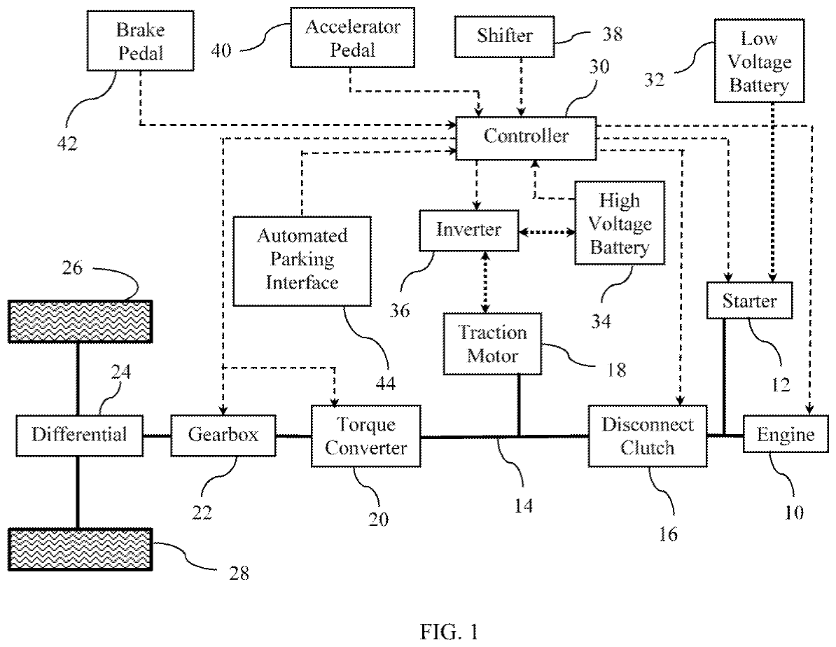

FIG. 1 schematically illustrates a hybrid powertrain. Bold solid lines indicate the flow of mechanical power. Dotted lines indicate the flow of electrical power. Dashed lines indicate the flow of information signals. Primary propulsive power is provided by internal combustion engine 10 which generates mechanical power by burning liquid fuel. The crankshaft of engine 10 must be rotating at least a minimum speed to sustain combustion and generate mechanical power. Low voltage starter motor 12 brings the engine up to this speed. The engine crankshaft is selectively coupled to transmission input shaft 14 by disconnect clutch 16. Traction motor 18 is fixedly coupled to transmission input shaft 14. The speed and torque provided to transmission input shaft 14 is adjusted to satisfy current vehicle needs by torque converter 20 and gearbox 22. Torque converter 20 transmits torque based on a speed difference between a turbine fixedly coupled to transmission input shaft 14 and an impeller fixedly coupled to the gearbox input. Torque converter 20 may also include a bypass clutch that selectively couples transmission input shaft 14 to the gearbox input to eliminate the parasitic losses associated with an open torque converter. Gearbox 22 selectively establishes a variety of speed ratios between the gearbox input shaft and a gearbox output shaft. Most commonly, this is accomplished by engaging particular clutches and brakes within gearbox 22. Differential distributes the power to left and right drive wheels 26 and 28 while allowing slight speed differences between the wheels, such as when turning a corner. The differential may also multiply the torque and reduce the speed by a fixed final drive ratio.

Controller 30 manages the powertrain by sending control signals to various of these components. Controller 30 sends a control signal to engine 10 and to starter 12 to start the engine. Starter 12 draws electrical power from low voltage battery 32. Low voltage battery 32 is recharged either by an engine driven alternator of by a DC/DC converter connected to high voltage battery 34. Once engine 10 is running, controller 30 sends control signals to engine 10 to adjust the torque delivered to the crankshaft. To transmit power from the crankshaft to downstream components, controller 32 sends control signals to disconnect clutch 16 causing it to engage. To stop the engine 10, controller 30 sends control signals to disconnect clutch 16 to disengage and then sends control signals to engine 10 to shut off. Controller 30 adjust the torque exerted on transmission input shaft 14 by traction motor 18 by sending control signals to inverter 36. An alternative way to start the vehicle is by engaging disconnect clutch 16 while the transmission input shaft 14 is being driven by traction motor 18. This method starts the engine more quickly than low voltage starter 12 and reduces wear on starter 12. However, precise control of traction motor torque is required in order to avoid unpleasant torque disturbances.

Controller 30 also sends signals to torque converter 20 to control engagement of the bypass clutch and to gearbox 22 to control which gear ratio is selected. The control signals to disconnect clutch 16, torque converter 20, and gearbox 22 may take the form of electrical signals to a valve body (not shown) which then sends control signals in the form of hydraulic pressures to particular clutches.

Controller 30 determines the desired operating state based on a number of signals. Among these signals are shifter 38, accelerator pedal 40, brake pedal 42, and automated parking interface 44. Controller 30 also receives a signal from battery 34 indicating the state of charge. Alternatively, the controller may estimate the battery state of charge based on other inputs. A driver interacts with shifter 38 to indicate desired direction of movement (Park, Reverse, Neutral, or Drive). The driver depresses accelerator pedal 40 to request positive wheel torque and depresses brake pedal 42 to request negative wheel torque in the specified direction.

The driver interacts with the automated parking interface to utilize an automated parking feature. This interaction occurs in two phases. In the first phase, the driver maneuvers the vehicle while the system identifies acceptable parking spots. After the system has identified a viable parking spot, the driver initiates the automated parking feature to initiate parking in the identified spot. During the parking maneuvers, controller 30 controls vehicle direction, power requests, and steering. In fact, the driver may elect to exit the vehicle prior to entering the parking spot.

In normal operation, the engine cycles on and off such that it can be operated at more efficient power levels. Internal combustion engines tend to be most efficient at power levels higher than average vehicle power requirements. When the engine efficiency can be improved by operating at a higher power level than currently requested by the driver, the engine torque is increased and traction motor 18 is operated at negative torque such that the power delivered to the wheels matches the driver request. The excess energy is stored in high voltage battery 34. At other times, this stored energy is used to propel the vehicle using traction motor 18 exclusively with the engine turned off and disconnect clutch 16 disengaged.

The transitions between engine running and engine stopped operating states may produce momentary torque disturbances in the powertrain. This is true whether the engine is started using traction motor 18 or starter motor 12, although the magnitudes of the disturbances may be different. When the nominal torque level is high, the disturbance torque due to the transition is less noticeable and can generally be managed by careful control of motor torque and disconnect clutch torque capacity. At low vehicle speeds and low nominal torque levels, such as during parking maneuvers, the torque disturbances associated with these transitions are substantially more difficult to accommodate.

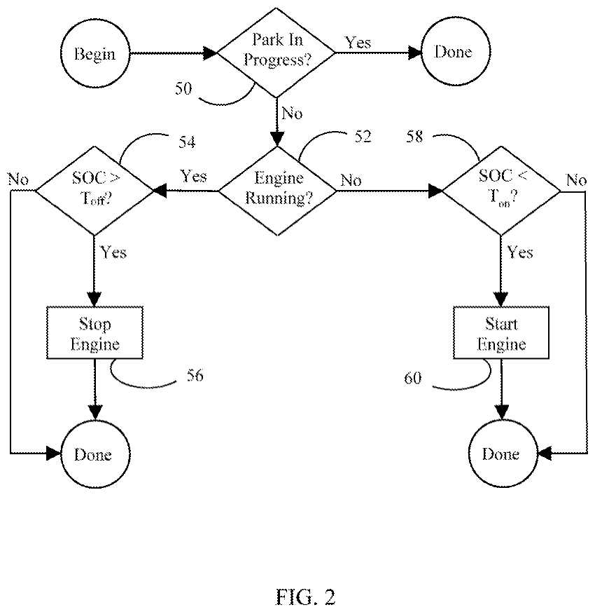

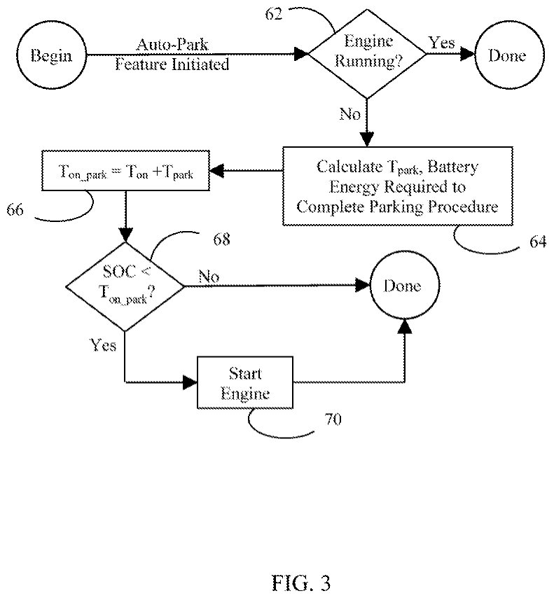

FIG. 2 illustrates a process for deciding when to start and stop the internal combustion engine. The process of FIG. 2 is executed at regular intervals, such as in response to a controller interrupt. The intervals are short enough (less than a second) that battery state of charge does not change by a large amount between intervals. This process is designed to work in conjunction with the process illustrated in FIG. 3 which is executed in response to initiation of the automated parking feature. At 50, the controller checks whether a parking maneuver is in progress. The parking maneuver is considered to be in progress from the time the user initiates the automated parking feature after identifying a parking spot until the vehicle is stopped in the parking spot. If a parkin maneuver is in progress, the method stops without changing the engine running state. Therefore, the engine is neither stopped nor started during an automated parking maneuver. If no parking maneuver is in progress, the controller checks the current engine running state at 52. If the engine is running, then the controller checks, at 54, whether the state of charge is greater than an engine off threshold T_{off}. If so, the engine is turned off at 56 before the method finishes. Otherwise, the method finishes with the engine still running. Similarly, if the engine is not running at 52, then the controller checks, at 58, whether the state of charge is less than an engine on threshold Tₒₙ. If so, the engine is started at 60 before the method finishes. Otherwise, the method finishes with the engine still off. Thus, when automated parking is not occurring, the engine is started in response to the state of charge decreasing below Tₒₙ and turned off in response to the state of charge increasing above T_{off}.

FIG. 3 illustrates the actions taken in response to the auto-park feature being initiated via interface 44. At 62, the controller checks whether the engine is currently running. If so, the method ends with the engine still running. Due to the logic in the process of FIG. 2, the engine will not be stopped at least until the vehicle is stopped in the parking space. At 64, the process calculates Tₚₐᵣₖ, the battery energy required to complete the parking maneuver. Various methods of performing this calculation are described below. At 66, the controller calculates a modified engine on threshold, T_{on_park}, by adding Tₚₐᵣₖ to the regular engine on threshold Tₒₙ. At 68, the controller compares the current battery state of charge to the modified engine on threshold. If the state of charge is less than the modified threshold, then the engine is started at 70. Therefore, if the state of charge is between the normal engine on threshold and the modified engine on threshold, such that it would ordinarily have been commanded to restart during the parking maneuver, then it is restarted before beginning the maneuver.

Several different ways of estimating the energy required at 64 are possible. The simplest method is to measure or simulate parking events using a prototype vehicle and program representative constants into the controller memory when the vehicle is manufactured. The events may be categorized into types of parking events such as parallel parking, head-in parking, and back-in parking. In a slightly more sophisticated strategy, the pre-programmed values may be adapted by measuring the change in battery state of charge during each parking maneuver and adjusting the value used on future initiations for that type of parking event. In another strategy, the controller may compute the distances to be travelled in each segment of the parking maneuver and calculate the energy required based on a sensed road grade, an estimated vehicle weight, and estimated parasitic losses in the driveline.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, embodiments described as less desirable than other embodiments or prior art implementations with respect to one or more characteristics are not outside the scope of the disclosure and can be desirable for particular applications.

What is claimed is:

1. A hybrid electric vehicle comprising:
an internal combustion engine;
a battery; and
a controller programmed to
start the engine responsive to a battery state of charge decreasing below a first threshold, and
start the engine responsive to initiation of an automated parking feature and the state of charge being greater than the first threshold and less than a second threshold.

2. The hybrid vehicle of claim 1 wherein the controller is further programmed to complete a parking procedure without starting the engine responsive to initiation of the automated parking feature and the state of charge being greater than the second threshold.

3. The hybrid vehicle of claim 1 wherein the controller is further programmed to
stop the engine responsive to a battery state of charge increasing to greater than a third threshold; and
delay stopping the engine until after an automated parking maneuver is completed in response to the state of charge increasing to greater than the third threshold during the automated parking maneuver.

4. The hybrid vehicle of claim 1 wherein the second threshold varies based on a type of parking maneuver to be performed.

5. The hybrid vehicle of claim 1 wherein the second threshold is adjusted based on a measured change in battery state of charge while completing a previous automated parking maneuver.

6. The hybrid vehicle of claim 1 wherein the controller is further programmed to calculate the second threshold based on segment distances and driveline loss properties.

7. A hybrid electric vehicle comprising:
an internal combustion engine;
a battery; and
a controller programmed to respond to a request for an automated parking feature by
starting the engine before starting the parking procedure responsive to a battery state of charge being less than a first threshold, and
completing the parking procedure without starting the engine responsive to the state of charge being greater than the first threshold.

8. The hybrid vehicle of claim 7 wherein the controller is further programmed to start the engine prior to initiation of the automated parking feature responsive to the state of charge decreasing below a second threshold less than the first threshold.

9. The hybrid vehicle of claim 7 wherein the controller is further programmed to
stop the engine responsive to a battery state of charge increasing to greater than a third threshold; and
delay stopping the engine until after the automated parking maneuver is completed in response to the state of charge increasing to greater than the third threshold during the automated parking maneuver.

10. The hybrid vehicle of claim 7 wherein the first threshold varies based on a type of parking maneuver to be performed.

11. The hybrid vehicle of claim 7 wherein the first threshold is adjusted based on a measured change in battery state of charge while completing a previous automated parking maneuver.

12. The hybrid vehicle of claim 7 wherein the controller is further programmed to calculate the first threshold based on segment distances and driveline loss properties.

13. A method comprising:
starting an internal combustion engine responsive to a battery state of charge decreasing below a first threshold;
stopping the engine responsive to the battery state of charge increasing above a second threshold;
restarting the engine responsive to initiation of an automated parking feature and the battery state of charge being between the first threshold and a third threshold; and
completing a parking procedure without stopping the engine.

14. The method of claim 13 wherein the third threshold is selected such that completing the parking procedure without restarting the engine would result in the battery state of charge decreasing below the first threshold.

15. The method of claim 13 wherein the third threshold varies based on a type of parking procedure to be performed.

16. The method of claim 15 further comprising adjusting the third threshold based on a measured change in battery state of charge to complete an automated parking procedure.
